(19) United States
(12) Patent Application Publication
(10) Pub. No.: US 2020/0330810 A1
(43) Pub. Date: Oct. 22, 2020

(54) FIRE SUPPRESSION AGENT COMPOSITION

(71) Applicant: Kidde Technologies, Inc., Wilson, NC (US)

(72) Inventors: Terry Simpson, Wake Forest, NC (US); Adam Chattaway, Old Windsor (GB)

(21) Appl. No.: 16/413,166

(22) Filed: May 15, 2019

Related U.S. Application Data
(63) Continuation-in-part of application No. 16/388,975, filed on Apr. 19, 2019.

(51) Int. Cl. A62D 1/00

(52) U.S. Cl. CPC A62D 1/0092

(57) ABSTRACT

Disclosed is a fire suppression agent composition including CF₃I and an additional fire suppression agent selected from the group consisting of HFC-23, HFC-125, HFC-227ea, Novec 1230, and HCFO-1233zd(E), wherein the fire suppression agent composition passes the FAA aerosol can test.

### CROSS REFERENCE TO RELATED APPLICATIONS

This applications is a continuation in part of U.S. patent application Ser. No. 16/388,975 filed on Apr. 19, 2019 which is incorporated by reference herein in its entirety.

### BACKGROUND

Exemplary embodiments of the present disclosure pertain to the art of fire suppression agents.

Halon 1301 has frequently been employed as a fire suppression agent but there is currently a desire to replace Halon 1301 with more environmentally friendly fire suppression agents or blends of agents. CF₃I has been suggested as an alternative but faces obstacles. Solutions are needed for environmentally friendly fire suppression agents which incorporate CF₃I.

### BRIEF DESCRIPTION

Disclosed is a fire suppression agent composition including CF₃I and an additional fire suppression agent selected from the group consisting of HFC-23, HFC-125, HFC-227ea, Novec 1230, and HCFO-1233zd(E), wherein the fire suppression agent composition passes the FAA aerosol can test.

In addition to one or more of the features described above, or as an alternative to any of the foregoing embodiments, the fire suppression agent composition has a lower human toxicity than CF₃I.

In addition to one or more of the features described above, or as an alternative to any of the foregoing embodiments, CF₃I is present in an amount of 30 to 70 weight percent (wt %), based on the total weight of the fire suppression composition.

In addition to one or more of the features described above, or as an alternative to any of the foregoing embodiments, the additional fire suppression agent is present in an amount of 30 to 70 wt %, based on the total weight of the fire suppression composition.

In addition to one or more of the features described above, or as an alternative to any of the foregoing embodiments, the molar ratio of CF₃I to the additional fire suppression agent is 0.4 to 1.5.

In addition to one or more of the features described above, or as an alternative to any of the foregoing embodiments, the additional fire suppression agent has a boiling point lower than CF₃I. The difference between the boiling points is greater than or equal to 10° C. The difference between the boiling points is greater than or equal to 25° C.

### DETAILED DESCRIPTION

A detailed description of one or more embodiments of the disclosed composition are presented herein by way of exemplification and not limitation.

The FAA aerosol can test (FAA-ACT) simulates a fire in an aircraft cargo bay container that heats an aerosol can, causing it to burst and fueling an explosion. In the FAA-ACT, a heated container at about 16 bar, releases its contents (270 grams (g) ethanol, 90 g propane, and 90 g water), as a two-phase impulsive spray via a fast-acting valve. A continuous direct current arc across electrodes (6.4 mm gap, shielded from the high-velocity spray) located about 1 meter downstream of the valve ignites the mixture. The fireball expands into the chamber atmosphere of premixed ambient air, water vapor and suppressant. The temperature and pressure in the chamber increase over a time of about 1 second, and in the absence of suppressant, the peak pressure rise is about 2 bar. During each test, instruments record the pressure, temperature, visual images, and concentrations of agent and oxygen. Unconfined tests without suppressant create a 3.4 m diameter fire ball.

Currently there is no efficient, non-toxic replacement for Halon 1301 which has a low ozone depletion potential (ODP). Described herein is a fire suppression agent composition comprising CF₃I and an additional fire suppression agent selected from the group consisting of HFC-23, HFC-125, HFC-227ea, Novec 1230, and HCFO-1233zd(E), wherein the fire suppression agent composition passes the FAA aerosol can test.

CF₃I and blends including CF₃I are an environmentally attractive alternative to fire extinguishing agents like Halon 1301 because CF₃I has a lower ozone depletion potential than Halon 1301. The lower ozone depletion potential is due to the lower stability of the molecule. However, CF₃I does have an unsuitable toxicity profile. The blends described herein address these issues by providing a fire suppression agent composition that can pass the FAA-ACT, has a more acceptable toxicity profile than CF₃I and has a lower ozone depletion potential than Halon 1301.

The fire suppression agent composition includes CF₃I in combination with an additional fire suppression agent selected from the group consisting of HFC-23, HFC-125, HFC-227ea, Novec 1230, and HCFO-1233zd(E). The CF₃I may be present in an amount greater than or equal to 30 wt %, or, greater than or equal to 35 wt %, or, greater than or equal to 40 wt %, based on the total weight of the fire suppression agent composition. The CF₃I may be present in an amount less than or equal to 70 wt %, based on the total weight of the fire suppression agent composition.

The additional fire suppression agent may be present in an amount greater than or equal to 30 wt %, or, greater than or equal to 35 wt %, or, greater than or equal to 40 wt %, based on the total weight of the fire suppression agent composition. The additional fire suppression agent may be present in an amount less than or equal to 70 wt %, based on the total weight of the fire suppression agent composition.

Exemplary combinations are shown in the following table.

| | |
|---|---|
| CF₃I | HFC-125 |
| 45 wt % | 55 wt % |
| CF₃I | Novec 1230 |
| 44 wt % | 56 wt % |
| CF₃I | HCFO- |
| 66 wt % | 1233zd(e) |
| | 34 wt % |

In some embodiments the molar ratio of CF₃I to the additional fire suppression agent is 0.4 to 1.5, or, 0.5 to 1.3, or 1.0 to 1.2.

In some embodiments the additional fire suppression agent has a boiling point less than the boiling point of CF₃I. The difference between the boiling points can be greater than or equal to 10° C., or, greater than or equal to 30° C.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. A fire suppression agent composition comprising CF₃I and an additional fire suppression agent selected from the group consisting of HFC-23, HFC-125, HFC-227ea, dodecafluoro-2-methylpentan-3-one, and HCFO-1233zd(E), wherein the fire suppression agent composition passes the FAA aerosol can test and CF₃I is present in an amount of 30 to 70 wt %, based on the total weight of the fire suppression agent composition.

2-3. (canceled)

4. The composition of claim 1, wherein the additional fire suppression agent is present in an amount of 30 to 70 wt %, based on the total weight of the fire suppression agent composition.

5. The composition of claim 1, wherein the molar ratio of CF₃I to the additional fire suppression agent is 0.4 to 1.5.

6. The composition of claim 1, wherein the additional fire suppression agent has a boiling point lower than CF₃I.

7. The composition of claim 6, wherein the difference between the boiling points is greater than or equal to 10° C.

8. The composition of claim 6, wherein the difference between the boiling points is greater than or equal to 25° C.

9. The composition of claim 1, wherein the additional fire suppression agent selected from the group consisting of HFC-23, HFC-125, dodecafluoro-2-methylpentan-3-one, and HCFO-1233zd(E).

10. The composition of claim 1, wherein the additional fire suppression agent is selected from the group consisting of HFC-125, dodecafluoro-2-methylpentan-3-one, and HCFO-1233zd(E).

11. The composition of claim 1, wherein CF₃I is present in an amount of 40 to 70 wt %, based on the total weight of the fire suppression agent composition
